(19) United States
(12) Patent Application Publication
(10) Pub. No.: US 2002/0143574 A1
(43) Pub. Date: Oct. 3, 2002

(54) Integration of mobile imaging units into an application service provider for data storage and information system support

(76) Inventors: Thanos Karras, Mount Prospect, IL (US); Greg Angst, Cary, IL (US); Milton Silva-Craig, Arlington Heights, IL (US)

Correspondence Address: MCANDREWS HELD & MALLOY, LTD, 500 WEST MADISON STREET, SUITE 3400, CHICAGO, IL, 60661

(21) Appl. No.: 09/681,306

(22) Filed: Mar. 15, 2001

(51) Int. Cl. G06F 17/60

(52) U.S. Cl. 705/2

(57) ABSTRACT

A preferred embodiment of the present invention provides a method and system for integration of mobile imaging units into an application service provider for data storage and information system support. A preferred embodiment includes a mobile imaging unit including medical diagnostic equipment, a data center storing medical information in electronic form, and a mobile imaging unit/data center communication interface allowing medical information transmission between the mobile imaging unit and the data center. A preferred embodiment further includes a healthcare facility and a healthcare facility/data center communication interface allowing medical information transmission between the data center and the healthcare facility.

### BACKGROUND OF INVENTION

The preferred embodiments of the present invention generally relate to remotely accessible centralized data storage for mobile imaging units, and in particular relate to a method and system for integration of mobile imaging units into an application service provider for data storage and information system support.

Many healthcare facilities, such as hospitals and clinics, employ mobile imaging units to facilitate medical examination of patients. Mobile imaging units may include equipment for MR (magnetic resonance), CT (computerized tomography), and the like, to facilitate medical examination of patients. Because hospitals and clinics may not have adequate facilities or funding to handle all patients and examinations, hospitals and clinics may hire or purchase mobile imaging units to help perform medical diagnostic examinations, for example MR and CT imaging. The use of mobile imaging units helps to reduce patient overflow problems by providing healthcare facilities with additional resources for patient examination. Additionally, the use of mobile imaging units may provide access to technologically advanced imaging solutions on a cost-effective basis.

A typical mobile imaging unit may be scheduled among multiple healthcare facilities. Mobile imaging units (typically large trucks or vans) are usually positioned outside the healthcare facility. A patient may be sent from the hospital or clinic to the mobile unit. An image may be taken of a patient (such as a MR or CT image) in the mobile unit. Currently, the patient image is manually processed in the mobile unit. Commonly, the image is either printed on film or stored on media such as a floppy disk, CD-ROM, and the like. The stored image is typically manually transported (often called “sneaker net” in the art) from the mobile imaging unit to the hospital or clinic where the image may be further processed or stored. Alternatively, some mobile imaging units and hospitals transmit images from a mobile unit to a hospital or clinic via a cable network connection (such as an Ethernet connection in the parking lot).

Currently, image data collection from mobile units is decentralized. That is, examination data remains with the individual hospital or clinic location and is not available at other locations. Thus, a patient must return to the original imaging location to access examination data, or the examination data must be sent from one location to another. Therefore, the patient's choice of location is limited. There is a need for centralized data storage to enable the patient's choice of hospital or clinic location. There is a need for a method of aggregating patient imaging results from mobile imaging units to eliminate manual transfer of files and to facilitate interaction among mobile units and between mobile units and healthcare facilities.

Application Service Providers (ASPs) have been employed in the field of computers to allow for centralization of data. ASPs operate as hosts for data and applications. Typically, ASPs maintain applications and data in an off-site data center. ASPs have been hired by companies in the field of computers to manage data and computer applications. Companies may access data and applications via an ASP. Typically, in the computer field, companies remotely access data and applications via an ASP central data location.

In the field of computers, ASPs offer several desirable services, such as secure data storage, data backup, and redundant systems. Because ASPs offer such services, a customer of an ASP may not have to incur additional expenses for its own security, backup, and storage systems. In addition to functioning as a remote database, the ASP may host a number of applications that may be activated or accessed remotely by customers. By concentrating computing power and maintenance at the ASP, the ASP may offer continuous access to and support of the applications and alleviate the need for the customer to purchase and maintain its own expensive computer equipment.

For example, ASPs may provide installation, management, and support of applications and storage of data for many remote clients. Client data may be stored at a remote data center. Data may be retrieved from the remote data center via a communications medium such as the Internet or a private network. Additionally, ASPs may deliver applications such as email systems, resource planning systems, customer relationship management systems, human resource management systems, and proprietary applications to remote clients.

Although hospitals are not able to perform remote centralization, some hospitals may collect their data locally into a single database located on site. This database is typically called a Picture Archiving and Communication System (PACS). A PACS may be used to obtain, store, and distribute electronic images, such as electronic medical diagnostic images. A PACS may allow images to be archived in electronic form in a central location on site. A PACS may also allow images to be shared among different users because the images are locally centralized and able to accessed at numerous points on site. Convenient access to patient data through a PACS may improve individual hospital workflow by eliminating the need to physically transfer images and by providing multiple viewing stations for imaging results.

Typically, data stored in a PACS is stored as DICOM data. DICOM stands for Digital Imaging and Communications in Medicine. DICOM is a standard for image and information transmission. DICOM relates to the transfer of electronic data between medical diagnostic and imaging systems. The DICOM protocol may be employed in communication between medical devices and PACS. The DICOM standard enumerates a command set, data formats, interface specifications, communication protocols, and command syntax. The DICOM standard does not specify details of implementation.

As described above, communication between a mobile unit and a PACS at a location may be difficult. Additionally, data taken at any one facility is typically stored in a PACS at that facility and is not available elsewhere. The localization of data at a single facility presents problems in mobile use because of limitations on data access and availability. Thus, it may be advantageous for mobile imaging units to be able to centrally archive images and data. Today, data collection is performed using either sneaker-net (manual file transfer by disk or manual transfer of film) or via a physical wire-based network connection to the main facility (such as by a network connection in a hospital parking lot for the mobile imaging unit). Furthermore, data collection is done locally on a facility-by-facility basis.

Centralized electronic data access may improve workflow of a healthcare facility and reduce operational overhead by reducing physical file transfer by facility personnel. That is, a healthcare facility may not have to send someone to physically get films or disks from a mobile imaging unit or other healthcare facility.

Additionally, centralized data storage may serve to minimize local storage by a client and reduce on site management of films or disks by the healthcare facility.

Additionally, it may be advantageous for mobile imaging units to use central information systems for scheduling, ordering, and reporting. For example, centralized scheduling may encourage efficient use of mobile imaging units.

Additionally, centralized reporting may facilitate information exchange between mobile units and healthcare facilities.

Thus, a need exists for a method and apparatus for integration of mobile imaging units into an Application Service Provider for data storage and information system support.

### SUMMARY OF INVENTION

A preferred embodiment of the present invention provides a method and system for integration of mobile imaging units into an application service provider for data storage and information system support. A preferred embodiment includes a mobile imaging unit including medical diagnostic equipment, a data center storing medical information in electronic form, and a mobile imaging unit/data center communication interface allowing medical information transmission between the mobile imaging unit and the data center. A preferred embodiment further includes a healthcare facility and a healthcare facility/data center communication interface allowing medical information transmission between the data center and the healthcare facility. In a preferred embodiment an authentication module authorizes access to the data center. In a preferred embodiment, the data center may also store medical applications.

In a preferred embodiment, medical diagnostic information collected from a patient at a mobile imaging unit is transmitted to a data center and the medical diagnostic information is stored at the data center. In a preferred embodiment, the medical diagnostic information may be retrieved from the data center. In a preferred embodiment, access to the data center may be subject to authentication.

A healthcare facility may retrieve the medical diagnostic information from the data center. A mobile imaging unit may retrieve the medical diagnostic information from the data center.

### BRIEF DESCRIPTION OF DRAWINGS

FIG. 1 illustrates a remotely accessible centralized medical image data storage system used in accordance with a preferred embodiment of the present invention.

FIG. 2 illustrates a remotely accessible centralized medical image data storage system used in accordance with a preferred embodiment of the present invention.

FIG. 3 illustrates a remotely accessible centralized medical image data storage system used in accordance with a preferred embodiment of the present invention.

FIG. 4 illustrates a flowchart for transferring information from a mobile imaging unit to a data center according to a preferred embodiment of the present invention.

FIG. 5 illustrates a flowchart for transferring information from a data center to a mobile imaging unit according to a preferred embodiment of the present invention.

FIG. 6 illustrates a flowchart for transferring information from a data center to a healthcare facility according to a preferred embodiment of the present invention.

FIG. 7 shows a flowchart for integrating mobile imaging units into an application service provider for data storage and information system support in accordance with a preferred embodiment of the present invention.

### DETAILED DESCRIPTION

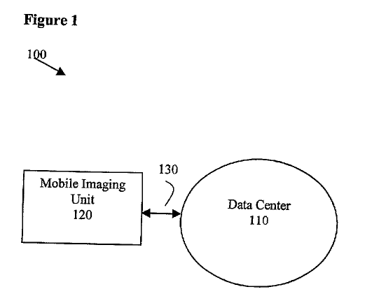

FIG. 1 illustrates a remotely accessible centralized medical image data storage system 100 used in accordance with a preferred embodiment of the present invention. The system 100 includes a plurality of subsystems, such as a data center 110, a mobile imaging unit 120, and a mobile imaging unit/data center communication interface 130.

The mobile imaging unit 120 connects to the data center 110 via the mobile imaging unit/data center communication interface 130. The mobile imaging unit/data center communication interface 130 may be a cellular network, a radio frequency (RF) wireless local area network (LAN), microwave network, satellite transmission network, wire-based network (such as Ethernet), as examples. In a preferred embodiment, the mobile imaging unit/data center communication interface 130 allows bidirectional communication. That is, the mobile imaging unit/data center communication interface 130 transmits data between the data center 110 and the mo-bile imaging unit 120.

The data center 110 preferably stores information such as images, examination data, and reports, for example. The data center 110 may also host applications, such as medical imaging applications, medical diagnostic applications, administrative applications, and scheduling applications, for example. Preferably, the applications are activated or accessed via the data center 110. The data center 110 may include processing power to facilitate the activation or access of the applications at the data center 110. Because the applications are activated or accessed at the data center 110, minimal computing capability may be employed at the mobile imaging unit 120 to execute medical applications. Centralized computing resources may reduce the costs of the mobile imaging unit 120 because minimal computing capability is employed at the mobile imaging unit 120.

In a preferred embodiment, the data center 110 is managed by an application server provider (ASP) located remotely from the mobile imaging unit 120. Preferably, the data center 110 is geographically distinct from the mobile imaging unit 120. In addition, the data center 110 may be managed by a company separate from the mobile imaging unit 120. The data center 110 may be accessed (for example, transmission or receipt of data or execution of applications) by the mobile imaging unit 120 via the mobile imaging unit/data center communication interface 130.

The mobile imaging unit 120 may include medical diagnostic equipment, such as MR (magnetic resonance) imaging equipment, CT (computerized tomography) imaging equipment, and/or ECG (electrocardiogram) equipment, as examples. The mobile imaging unit 120 may also include paramedic equipment, such as first aid equipment, cardiac equipment, and/or life support equipment, for example.

The mobile imaging unit 120 facilitates medical diagnostic examination of a patient (for example, a MR or CT scan). Data from the medical diagnostic examination (for example, an image) may be transmitted to the data center 110 via the mobile imaging unit/data center communication interface 130. The data center 110 may store the examination data for later retrieval by the mobile imaging unit 120 or other entity. Additionally, the medical imaging unit 120 may access medical applications via the data center 110.

As an example, a medical diagnostic examination of a patient is performed at the mobile imaging unit 120, and a resulting medical diagnostic image is obtained. Then, the mobile imaging unit 120 accesses the data center 110 via the mobile imaging unit/data center communication interface 130. Next, the mobile imaging unit 120 stores the medical diagnostic image at the data center 110. Storage and access of data occurs independent of the locations of the mobile imaging unit 120 and the data center 110.

As another example, multiple patient examinations may be scheduled at the mobile imaging unit 120. To perform scheduling, the mobile imaging unit 120 may access the data center 110. Next, the mobile imaging unit 120 may access a patient scheduling application hosted by the data center 110. Then, the mobile imaging unit 120 may execute the patient scheduling application via the data center 110 and thus schedule patient examinations.

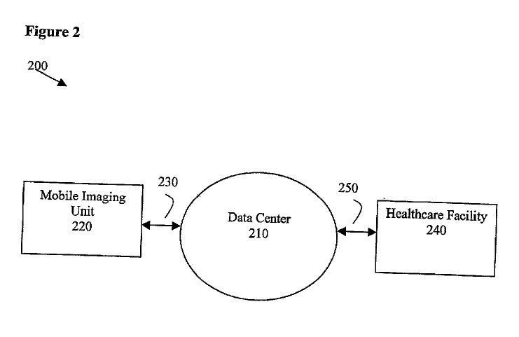

FIG. 2 illustrates a remotely accessible centralized medical image data storage system 200 used in accordance with a preferred embodiment of the present invention. The system 200 includes a plurality of subsystems, such as a data center 210, a mobile imaging unit 220, a mobile imaging unit/data center communication interface 230, a healthcare facility 240, and a healthcare facility/data center communication interface 250.

As described above in reference to FIG. 1, the mobile imaging unit/data center communication interface 230 provides a bi-directional data connection between the mobile imaging unit 220 and the data center 210. In an alternative embodiment, the mobile imaging unit/data center communication interface 230 includes a bidirectional data connection between the mobile imaging unit 220 and the data center 210 through the healthcare facility 240.

The healthcare facility/data center communication interface 250 provides a bidirectional data connection between the healthcare facility 240 and the data center 210. Preferably the healthcare facility/data center communication interface 250 is the Internet, a private network, or a wireless network, as examples.

The mobile imaging unit 220 is similar to the mobile imaging unit 120 described above in reference to FIG. 1. The mobile imaging unit 220 facilitates medical diagnostic examination of patients. Data from the medical diagnostic examination may be transmitted to the data center 210 via the mobile imaging unit/data center communication interface 230.

The data center 210 is similar to the data center 110 described above in reference to FIG. 1. The data center 210 preferably stores information (such as images, examination data, reports, etc.) and applications (such as medical imaging applications, medical diagnostic applications, administrative applications, scheduling applications, etc.). The mobile imaging unit 220 and the healthcare facility 240 may access or activate applications at the data center 210. In a preferred embodiment, the data center 210 is managed by an ASP located remotely from the healthcare facility 240. Preferably, the data center 210 is geographically distinct from the healthcare facility 240.

The healthcare facility 240 is preferably a hospital, a medical clinic, a doctor's office, some other medical office, or any other terminal, for example. The healthcare facility 240 may include medical diagnostic imaging equipment, such as MR imaging equipment, CT imaging equipment, and/or ECG equipment, as examples. The healthcare facility 240 may also include patient treatment equipment, such as first aid equipment, cardiac support equipment, and/or life support equipment, for example.

As described above in relation to FIG. 1, the mobile imaging unit 220 facilitates medical diagnostic examination of a patient (for example, a MR or CT scan). Data from the medical diagnostic examination (for example, an image) may be transmitted to the data center 210 via the mobile imaging unit/data center communication interface 230. The data center 210 may then store the examination data for later access by the healthcare facility 240 or the mobile imaging unit 220, for example. Then, a user at the healthcare facility 240 may access the examination data from the data center 210 via the healthcare facility/data center communication interface 250. In a preferred embodiment, “dumb” terminals (e.g., a keyboard and display without advanced processing power) at the healthcare facility 240 may access the examination data from the data center 210 via the healthcare facility/data center communication interface 250. Operators such as healthcare professionals (for example, physicians, radiologists, etc.) may view the mobile imaging unit 220 examination results at the healthcare facility 240 by accessing the data center 210. Examination results may be viewed using a DICOM translation and viewing program, for example. The physical locations of the mobile imaging unit 220, data center 210, and healthcare facility 240 do not adversely impact the operation of the preferred embodiments of the present invention.

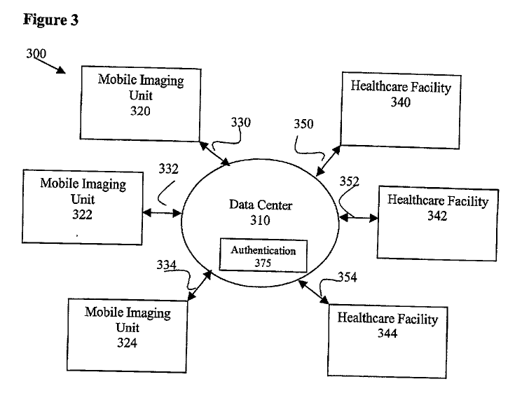

FIG. 3 illustrates a remotely accessible centralized medical image data storage system 300 used in accordance with a preferred embodiment of the present invention. The system 300 includes a plurality of subsystems, such as a data center 310, mobile imaging units 320, 322, 324, mobile imaging unit/data center communication interfaces 330, 332, 334, healthcare facilities 340, 342, 344, and healthcare facility/data center communication interfaces 350, 352, 354.

The mobile imaging unit/data center communication interfaces 330, 332, 334 are similar to the mobile imaging/unit data center communication interface 230 of FIG. 2. As described above in reference to FIG. 2, the mobile imaging unit/data center communication interfaces 330, 332, 334 allow bidirectional communication between the mobile imaging units 320, 322, 324 and the data center 310. In an alternative embodiment, as described above in reference to FIG. 2, the mobile imaging unit/data center communication interfaces 330, 332, 334 include bidirectional data connections between the mobile imaging units 320, 322, 324 and the data center 310 through the healthcare facilities 340, 342, 344.

The healthcare facility/data center communication interfaces 350, 352, 354 are similar to the healthcare facility/data center communication interface 250 of FIG. 2. As described above in reference to FIG. 2, the healthcare facility/data center communication interfaces 350, 352, 354 allow bidirectional communication between the healthcare facilities 340, 342, 344 and the data center 310.

The mobile imaging units 320,322,324 are similar to the mobile imaging unit 220 described above in reference to FIG. 2. In operation, first the mobile imaging units 320, 322, 324 facilitate medical diagnostic examination of patients to generate medical diagnostic information. Then, the mobile imaging units 320, 322, 324 transmit medical diagnostic information to the data center 310 via the mobile imaging unit/data center communication interfaces 330, 332, 334.

Additionally, the mobile imaging units may also access applications at the data center 310 via the mobile imaging unit/data center communication interfaces 330, 332, 334.

The data center 310 is similar to the data center 210 described above in reference to FIG. 2. The data center 310 preferably stores information such as images, examination data, and/or reports, for example. The data center 310 may also store applications, such as medical imaging applications, medical diagnostic applications, administrative applications, and/or scheduling applications, as examples. Preferably, applications stored at the data center 310 are activated or accessed at the data center 310 by a remote user, for example, the mobile imaging units 320, 322, 324 or the healthcare facilities 340, 342, 344.

The healthcare facilities 340, 342, 344 are similar to the healthcare facility 240 described above in reference to FIG. 2. Users at the healthcare facilities 340, 342, 344 may access medical diagnostic examination data (for example, images, reports, etc.) at the data center 310 via the healthcare facility/data center communication interfaces 350, 352, 354. Additionally, users at the healthcare facilities 340, 342, 344 may access medical applications (for example, scheduling applications, medical diagnostic applications, etc.) at the data center 310 via the healthcare facility/data center communication interfaces 350, 352, 354.

The system 300 is representative of one embodiment of the present invention. In practice, a variable number of mobile imaging units 320, 322, 324, a variable number of healthcare facilities 340, 342, 344, a variable number of mobile imaging unit/data center communication interfaces 330, 332, 334, and a variable number of healthcare facility/data center communication interfaces 350, 352, 354 may be included in the system 300. However, each of the components of the system 300 may aggregate or access data at the data center 310. Additionally, the data center 310 may be one or more servers. Furthermore, the data center 310 may be cached and stored at multiple locations. Also, the data center 310 may be spatially distant from the other components of the system 300.

In an alternative embodiment, which may be applied to any of the embodiments disclosed herein, an authentication module 375 is used to protect the contents of the data center 310. That is, the mobile imaging units 320, 322, 324 may transmit an authentication code to the authentication module 375 in order gain access to the data center 310 to transmit or receive data or access applications. Also, the healthcare facilities 340, 342, 344 may transmit an authentication code to the authentication module 375 in order to gain access to the data center 310 to transmit or receive data or access applications.

When the authentication code is transmitted to the authentication module 375, the authentication module 375 compares the received authentication code with a predetermined authentication code. If the authentication code matches, then the authentication code has been verified by the data center 310 and access to the data center 310 is granted. That is, if the authentication code is verified, the authentication module 375 allows access to the data center 310. In one embodiment, the authentication code includes a secure identification key. Preferably, the secure identification key is a periodically changing number. The secure identification key may be embodied in a device that generates a periodically changing number. Additionally, the authentication code may include an identification number (preferably a personal identification number) along with the secure identification key. Alternatively, the authentication code may be a password.

In an alternative embodiment, for additional data security, data may be encrypted during transmission over the mobile imaging unit/data center communication interface 330, 332, 334 and/or the healthcare facility/data center communication interface 350, 352, 354. Several commercially available encryptions may be employed that are known to those skilled in the art. Preferably, 128-bit keyed Huffman encoding is employed. Encryption may help preserve confidentiality of medical records and the like.

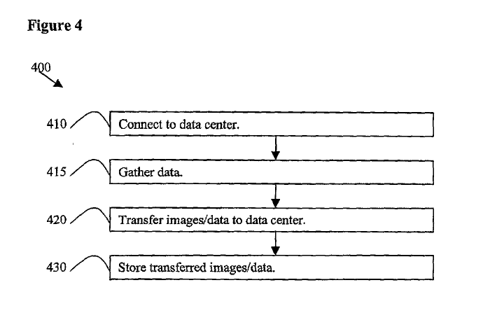

FIG. 4 illustrates a flowchart 400 for transferring information from a data generator (such as a mobile imaging unit 220 or a healthcare facility 240) to a data center 210 according to the remotely accessible centralized medical image data storage system of FIG. 2. First, at step 410, the data generator connects to the data center 210. Preferably, the data generator connects to the data center 210 via a communication interface (such as a mobile imaging unit/data center communication interface 230 or healthcare facility/data center communication interface 240, as described above in reference to FIG. 2). Then, at step 415 data is gathered. For example, an image or other medical data may be gathered at the data generator. Next, at step 420, the data generator transfers information, such as images and/or data, to the data center 210. Finally, at step 430, the data center 210 stores the transferred information. The information may be stored for later retrieval by the data generator or another entity.

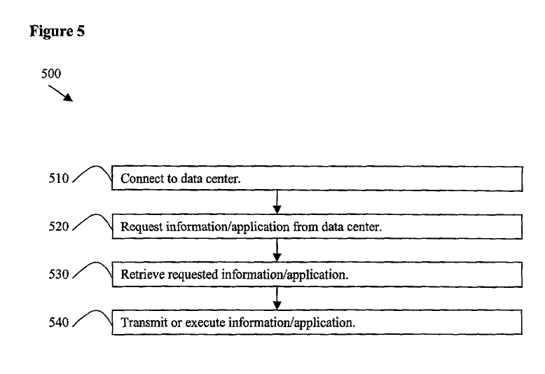

FIG. 5 illustrates a flowchart 500 for transferring information from a data center 210 to a data receiver (such as a mobile imaging unit 220 or a healthcare facility 240) according to the remotely accessible centralized medical image data storage system of FIG. 2. First, at step 510, the data receiver connects to the data center 210. Preferably, the data receiver connects to the data center 210 via a communication interface (such as a mobile imaging unit/data center communication interface 230 or a healthcare facility/data center communication interface, as described above in reference to FIG. 2). Next, at step 520, the data receiver requests information (such as image or data, as examples) or an application (such as a medical imaging application, medical diagnostic application, administrative application, scheduling application, as described above) from the data center 210. Then, at step 530, the data center 210 retrieves the requested information or application from its internal storage. Finally, at step 540, the data center 210 transmits the requested information or application to the data receiver or executes the requested application for the data receiver.

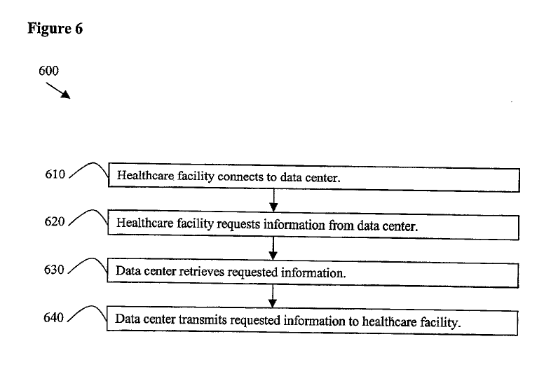

FIG. 6 illustrates a flowchart 600 for transferring information from a data center 210 to a healthcare facility 240 according to the remotely accessible centralized medical image data storage system of FIG. 2. First, at step 610, the healthcare facility 240 connects to the data center 210. Preferably, the healthcare facility 240 connects to the data center 210 via a healthcare facility/data center communication interface 250 (as described above). Next, at step 620, the healthcare facility 240 requests information (such as a medical image or data, as examples) or an application (such as a medical diagnostic application, a medical imaging application, an administrative application, a scheduling application, for example) from the data center 210. Then, at step 630, the data center 210 retrieves the requested information or application from its internal storage. Finally, at step 640, the data center 210 transmits the requested information to the healthcare facility 240 or executes the requested application for the healthcare facility 240.

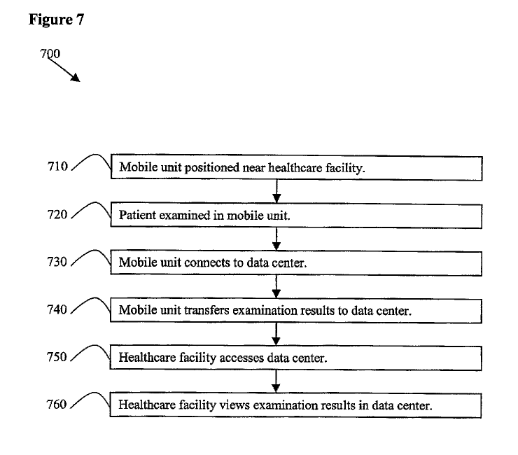

FIG. 7 shows a flowchart 700 for integrating mobile imaging units 220 into an application service provider for data storage and information system support in accordance with the remotely accessible centralized medical image data storage system of FIG. 2. First, at step 710, the mobile imaging unit 220 is preferably positioned near the healthcare facility 240. Next, at step 720, an examination, such as a MR imaging scan, for example, of a patient is performed at the mobile imaging unit 220.

Then, at step 730, the mobile imaging unit 220 connects to the data center 210. Alternatively, the mobile imaging unit 220 may connect to the data center 210 when first positioned. Also, the mobile imaging unit 220 may connect to the data center during examination. At step 740, the mobile imaging unit 220 transmits the examination results (images, data, etc.) to the data center 210. Preferably, the examination data is transmitted in DICOM format. Additionally, the examination data may be compressed to increase speed of transmission or be encrypted to prevent unauthorized interception of the data. Additionally, a user may be authenticated to prevent unauthorized access to the data. Alternatively, rather than transmitting the data directly from the mobile imaging unit 220 to the data center 210, the mobile imaging unit 220 may transmit data to the healthcare facility 240 which then transmits the data to the data center 210.

Then, at step 750, the healthcare facility 240 may access the data center 210.

Again, as above, to prevent unauthorized access to the data, a user may be authenticated. Finally, at step 760, users at the healthcare facility 240 may view the examination results or other information via the data center 210. The physical locations of the mobile imaging unit 220, the healthcare facility 240, and the data center 210 do not adversely impact the operation of the preferred embodiments of the present invention. For example, the mobile imaging unit 220 may be located far away (for example, in another city) from the healthcare facility 240 or the data center 210. Alternatively, the data center 210 may be located in a different geographic region (for example, GE Medical Systems corporate headquarters). The freedom from geographic constraints provides the remote accessibility of the data center 210 and facilitates remote diagnosis or analysis of examination results or other information.

As an example, a mobile imaging unit M1 may be servicing healthcare facilities H1 and H2. First, mobile imaging unit M1 may be positioned at healthcare facility H1. Mobile imaging unit M1 may examine patients at healthcare facility H1 and perform, for example, CT scans of patients. Next, mobile imaging unit M1 may be requested at healthcare facility H2. Rather than physically transporting patient examination results to healthcare facility H1, mobile imaging unit M1 may upload patient examination results to a data center D1 while traveling to healthcare facility H2, for example, by a wireless communication interface. Users at the healthcare facility H1 may view the patient examination results via the data center D1 at any time. Meanwhile, the mobile imaging unit M1 may examine additional patients at the second healthcare facility H2.

Additionally, the embodiments of the present invention may be used to collect data for use in medical studies, such as clinical trial studies, for example. That is, the centralized data aggregation provided by the preferred embodiments of the present invention by offer easy access to statistical data or other medical data for statistical analysis. For example, a company may own at least one mobile imaging unit in at least one location. The company may want to collect benchmark data for purposes such as aggregating examination results and testing equipment performance, for example. Mobile imaging units in various locations may transfer data to the data center. Users may view the aggregated data via the data center. Data aggregation in a data center may allow benchmarking of equipment performance across healthcare facilities, business management, equipment accuracy, and the like. Additionally, a company or healthcare facility could aggregate data from imaging studies all over the country and perform benchmarking for specific diseases (to facilitate disease management, diagnosis/treatment outcomes, etc.).

Thus, the preferred embodiments of the present invention provide a simple solution to what has become a serious issue of time, monetary, and personnel resources for the healthcare industry, such as the availability or flexibility of imaging facilities to satisfy client demand while at a healthcare facility. The present method and system for integration of mobile imaging units into an application service provider for data storage and information system support may provide centralized information storage and access and reduce the resources needed to coordinate between mobile imaging units and healthcare facilities. Additionally, the centralized storage may allow benchmarking of examination and imaging data. Thus, mobile imaging units and healthcare facilities may conveniently share and compare data and images in various physical locations. That is, relatively immediate access to examination images and data independent of location is provided. Additionally, later analysis may be performed easily at another facility or remote location.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A remotely accessible centralized medical information system, said system comprising:
a data generator for generating medical data storable in a data center;
at least one data retriever for retrieving data from a data center; and
a data center for storing data, said data center accessible from said at least one data retriever, said at least one data retriever located at at least one distinct geographic retrieval point.

2. The system of claim 1, wherein said data generator comprises a mobile imaging unit.

3. The system of claim 1, wherein said data retriever comprises a mobile imaging unit.

4. The system of claim 1, wherein said data retriever comprises a healthcare facility.

5. The system of claim 1, wherein said data generator comprises a healthcare facility.

6. The system of claim 1, wherein said data center comprises an application service provider.

7. The system of claim 1, wherein said data generator generates medical images.

8. The system of claim 1, wherein said data generator generates medical reports.

9. A centralized medical information system, said system comprising:
a data generator for generating data storable in a data center; and
a data center for storing data, said data center geographically distinct from said data generator.

10. The system of claim 9, wherein said data generator comprises a mobile imaging unit.

11. The system of claim 9, wherein said data generator comprises a healthcare facility.

12. The system of claim 9, wherein said data center comprises an application service provider.

13. A centrally accessible medical information system, said system comprising:
a data retriever for retrieving data from a data center; and
a data center for storing data, said data center geographically distinct from said data retriever.

14. The system of claim 13, wherein said data retriever comprises a healthcare facility.

15. The system of claim 13, wherein said data retriever comprises a mobile imaging unit.

16. The system of claim 13, wherein said data center comprises an application service provider.

17. A remotely accessible centralized medical application service provider system, said system comprising:
a data center including at least one medical application, said data center including processing power for accessing said medical application; and
a data retriever, said data retriever accessing the output of said medical application.

18. The system of claim 17, wherein said medical application retriever comprises a mobile imaging unit.

19. The system of claim 17, wherein said medical application retriever comprises a healthcare facility.

20. The system of claim 17, wherein said medical application center also stores administrative applications.

21. A remotely accessible centralized data storage system for mobile medical imaging, said system comprising:
a mobile imaging unit including medical imaging equipment;
a data center storing medical information in electronic form; and
a mobile imaging unit/data center communication interface allowing medical information to be transmitted between said mobile imaging unit and said data center.

22. The system of claim 21, further comprising a healthcare facility and a healthcare facility/data center communication interface allowing medical information transmission between said data center and said healthcare facility.

23. The system of claim 22, further comprising an authentication module for authorizing access to said data center from at least one of said healthcare facility and said mobile imaging unit.

24. A method for remotely storing medical information, said method comprising:
transmitting medical information collected from a patient at a mobile imaging unit to a data center; and
storing said medical information at said data center.

25. The method of claim 24, wherein said step of storing includes authenticating access to said data center.

26. The method of claim 24, further comprising the step of retrieving said medical diagnostic information from said data center.

27. The method of claim 26, wherein the step of retrieving includes authenticating access to said data center.

28. A method of communicating between a mobile imaging unit and a healthcare facility, said method comprising:
transmitting information from said mobile imaging unit to a data center; and
retrieving said information from said data center at said healthcare facility.

29. A system for communication between a mobile imaging unit and a healthcare facility, said system comprising:
a mobile imaging unit capable of transmitting medical diagnostic information;
a data center capable of receiving said medical diagnostic information, storing said medical diagnostic information, and transmitting said medical diagnostic information; and
a healthcare facility capable of accessing said medical diagnostic information from said data center.

30. The system of claim 29, wherein said data center is further capable of storing medical applications and executing medical applications.

31. The system of claim 30, wherein said mobile imaging unit is further capable of executing medical applications via said data center.

32. The system of claim 30, wherein said healthcare facility is further capable of executing medical applications via said data center.

33. A method for remotely accessing medical information, said method comprising:
accessing a data center from a remote location; and
retrieving medical information from said data center.

34. The method of claim 33, wherein said step of accessing includes authenticating access to said data center.
